(19) United States
(12) Patent Application Publication
(10) Pub. No.: US 2025/0021365 A1
(43) Pub. Date: Jan. 16, 2025

(54) METHOD FOR EFFICIENT LOW-LATENCY INTEGRATION OF WEBASSEMBLY CONTAINERS

(71) Applicant: VMware LLC, Palo Alto, CA (US)

(72) Inventors: Rusko ATANASOV, Sofia (BG); Antonina USKOVA, Smolyan (BG); Gancho MANEV, Sofia (BG); Vesselin ARNAUDOV, Sofia (BG)

(21) Appl. No.: 18/350,504

(22) Filed: Jul. 11, 2023

(51) Int. Cl. G06F 9/455

(52) U.S. Cl. CPC G06F 9/45558; G06F 2009/45575

(57) ABSTRACT

A system and method for reducing the startup times of applications are described. A plugin extension to a worker node of an orchestration system is established. The plugin extension, once started, is not stopped. The plugin extension comprises one or more lightning containers and a pool of threads/fibers. Each lightning container comprises a virtual machine, such as a WebAssembly virtual machine, to which a thread or fiber from the pool is assigned to run the application. Multiple applications run concurrently as long as threads/fibers are available from the pool. When an application is completed, the thread assigned to it is returned to the thread/fiber pool for re-use.

### BACKGROUND

Containers, such as Docker containers, have established themselves as a useful packaging, deployment, and maintenance tool for server-side software applications. For certain classes of customers and given scenarios, such as execution of functions-as-a-service (server-less) or low-latency workloads (such as telecommunication companies), it is desirable to keep the usability properties of containers (such as a Kubernetes® orchestration system and workload sandboxing) but also reduce startup times, such as cold-start times, where a cold-start time is the time between requesting for the first time that an application run and the actual running of the application.

### BRIEF DESCRIPTION OF DRAWINGS

FIG. 1A depicts a representative host computer system with virtualization.

FIG. 1B depicts a representative host computer system.

FIG. 2 depicts an arrangement for running containers.

FIG. 3 depicts an arrangement for running containers with an orchestration system.

FIG. 4 depicts a WebAssembly arrangement.

FIG. 5 depicts an arrangement for running containers with a proxy-plugin process, in an embodiment.

FIG. 6 depicts a flow of operations for running applications, in an embodiment.

### SUMMARY

Embodiments described herein reduce, in some cases by approximately 60%, the cold-start times of running a containerized application while maintaining compatibility with a container orchestrator, such as Kubernetes®. In addition, the embodiments enable portable workloads across different CPU architectures, such as x86 and ARM, instead of being bound to a specific CPU architecture.

One embodiment presented is a method for reducing startup times of applications. The method includes starting a proxy plugin process coupled to a worker node of an orchestration system, where the proxy plugin process includes a pool of threads or fibers for running applications. The method further includes loading a first application into a first virtual machine, assigning one thread or fiber from a pool thereof to the first virtual machine to run the first application, and running the first application. The method further includes loading a second application into a second virtual machine, assigning one other thread or fiber from the pool to the second virtual machine to run the second application, and running the second application. The method further includes returning the one thread or fiber to the pool for re-use by other applications upon termination of the first application.

Further embodiments include a computer-readable medium containing instructions for carrying out one more aspects of the above method and a computer system configured to carry out one or more aspects of the above method.

### DETAILED DESCRIPTION

Techniques described herein relate to reducing cold-start times for containers while providing compatibility with a container orchestrator. In particular, certain embodiments involve the use of an instruction format such as WebAssembly (WASM) to enable workload sandboxing and portability (e.g., via WASM virtual machines), as well as the use of threads running in a single dedicated process that is started only once. For example, each workload (e.g., application, VM, and/or the like) may run in a green thread (e.g., a thread that is scheduled by a user-level process rather than a kernel).

In order to enable compatibility with a container orchestrator, a proxy plugin process may be used for the single dedicated process. For example, the container orchestrator may delegate tasks to an external service, such as the proxy plugin process, utilizing a remote procedure call (RPC) framework, such as gRPC. In certain embodiments, the proxy plugin process is activated only once, thus reducing cold-start times because once started, it is not restarted for new workloads. It re-uses existing threads of a thread/fiber pool created only once within the lifetime of the process. Re-using a dedicated process without restarting it, and within it, re-using threads or fibers from a thread/fiber pool saves tens of milliseconds because cold-start times of containers, such as Docker® containers, are avoided.

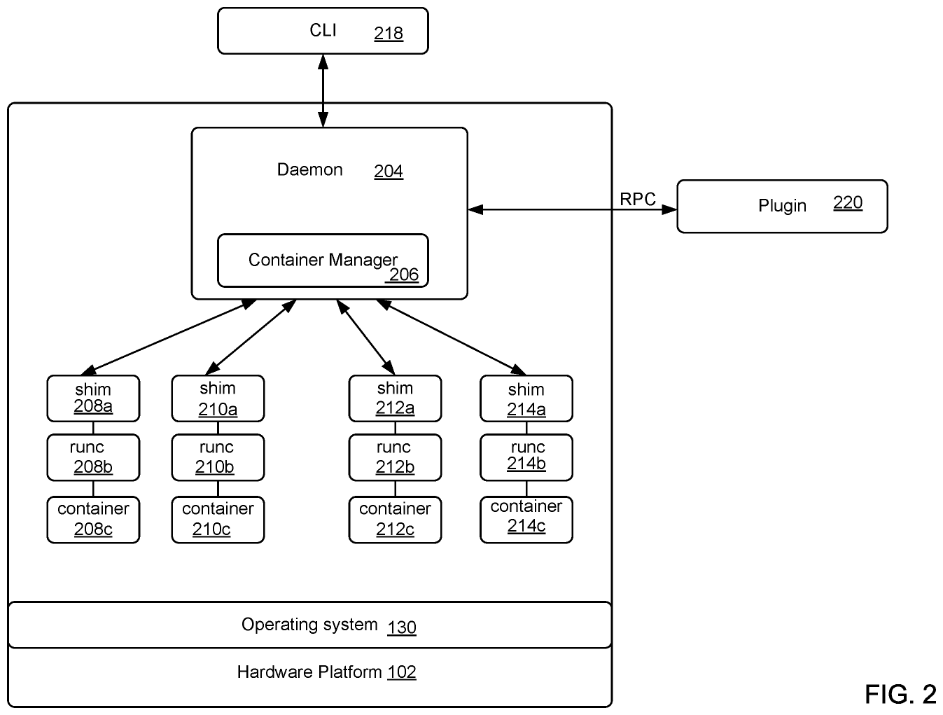

As described in more detail below with respect to FIGS. 2-5, certain embodiments involve running applications (i.e., workloads) in lightning containers, that is, in virtual machines, such as WASM virtual machines, to which are assigned reusable threads of a thread pool, where each WASM virtual machine runs in a proxy-plugin process that is started only once, and where a container orchestrator communicates with the proxy-plugin process via an RPC framework.

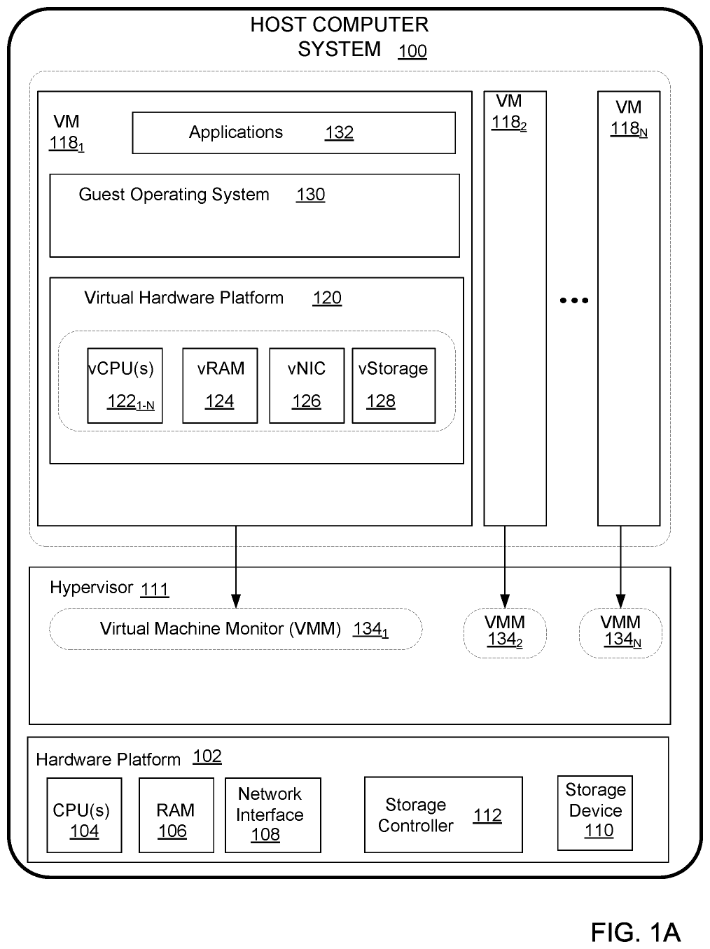

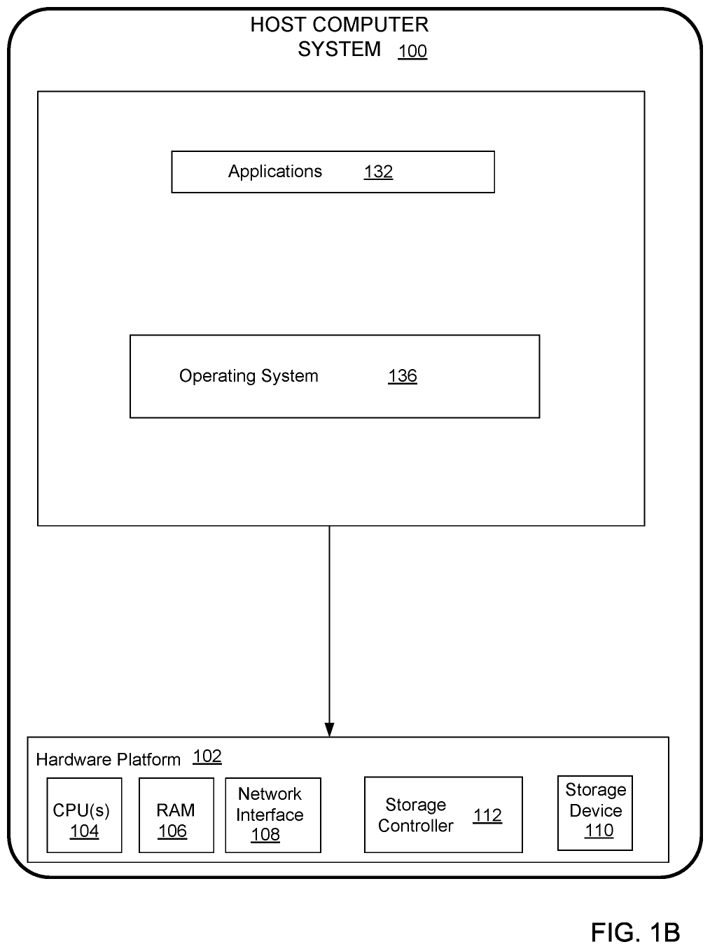

FIG. 1A depicts a block diagram of a host computer system 100 that is representative of a virtualized computer architecture. As is illustrated, host computer system 100 supports multiple virtual machines (VMs) 1181-118N, which are an example of virtual computing instances (VCIs) that run on and share a common hardware platform 102. Hardware platform 102 includes conventional computer hardware components, such as random access memory (RAM) 106, one or more network interfaces 108, storage controller 112, persistent storage device 110, and one or more central processing units (CPUs) 104. CPUs 104 may include processing units having multiple cores.

A virtualization software layer, hereinafter referred to as a hypervisor 111, is installed on top of hardware platform 102. Hypervisor 111 makes possible the concurrent instantiation and execution of one or more VMs 1181-118N. The interaction of a VM 118 with hypervisor 111 is facilitated by the virtual machine monitors (VMMs) 1341-134N. Each VMM 1341-134N is assigned to and monitors a corresponding VM 1181-118N. In one embodiment, hypervisor 111 may be a VMkernel™ which is implemented as a commercial product in VMware's vSphere® virtualization product, available from VMware™ Inc. of Palo Alto, CA. In an alternative embodiment, hypervisor 111 runs on top of a host operating system, which itself runs on hardware platform 102. In such an embodiment, hypervisor 111 operates above an abstraction level provided by the host operating system.

After instantiation, each VM 1181-118N encapsulates a virtual hardware platform 120 that is executed under the control of hypervisor 111. Virtual hardware platform 120 of VM 1181, for example, includes but is not limited to such virtual devices as one or more virtual CPUs (vCPUs) 1221-122N, a virtual random access memory (vRAM) 124, a virtual network interface adapter (vNIC) 126, and virtual storage (vStorage) 128. Virtual hardware platform 120 supports the installation of a guest operating system (guest OS) 130, which is capable of executing applications 132. Examples of guest OS 130 include any of the well-known operating systems, such as the Microsoft Windows™ operating system, the Linux™ operating system, and the like.

FIG. 1B depicts a representative host computer system without virtualization. Hardware platform 102 includes conventional computer hardware components, such as random access memory (RAM) 106, one or more network interfaces 108, storage controller 112, persistent storage device 110, and one or more CPUs 104. CPUs 104 may include processing units having multiple cores.

Hardware platform 102 supports the installation of an operating system (OS) 136, which is capable of executing applications 132. Examples of OS 136 include any of the well-known operating systems, such as the Microsoft Windows™ operating system, the Linux™ operating system, and the like.

FIG. 2 depicts an arrangement for running containers. In the figure, a host computer system, such as that depicted in FIG. 1A or FIG. 1B, includes a hardware platform 102, an operating system 130, 136, such as the Linux™ operating system, and a number of containers 208c, 210c, 212c, 214c. The arrangement also includes a daemon process 204, a container manager 206, a shim 208a, 210a, 212a, 214a, and a runtime (runc) 208b, 210b, 212b, 214b for each container 208c, 210c, 212c, 214c.

Daemon process 204 exposes an application programming interface (API). Daemon process 204 receives commands from a client or user via a command line interface 218 (CLI) for controlling containers.

Container manager 206 within daemon process 204 manages the complete container lifecycle on a single host, including creating and stopping containers, pulling and storing images, configuring mounts, and networking. Container manager 206 is designed to be embeddable into larger systems. Some container managers 206, such as containerd, can have a proxy-plugin process 220 for extending their operation with third-party software.

Proxy-plugin process 220 may be an external process that runs independently of daemon process 204, or proxy-plugin process 220 may be integrated into daemon process 204. Proxy-plugin process 220 has an API that is responsive to a remote procedure call (RPC) that works over the hypertext transfer protocol (HTTP).

Runtime (runc) 208b, 210b, 212b, 214b creates a namespace and a control group (cgroup) required for each container 208c, 210c, 212c, 214c upon request to operating system 130. Runtime 208b, 210b, 212b, 214b then runs the container commands inside the namespace and control group.

After the container is created and runc ends, shim 208a, 210a, 212a, 214a becomes the container's parent process. Shim 208a, 210a, 212a, 214a keeps STDIN, STDOUT, and STDERR streams open and reports the container's exit station back to container manager 206.

A container's life cycle includes a running phase, which is entered by a start command, a restart command, or an ‘unpause’ command after being paused. A start command occurs after a create command or a run command. When a running container exits, it may be restarted or deleted.

The container itself runs an application with layers of images pulled from a registry of images. The image layers running in the container cannot be changed while the container is running. A change requires building a new image that includes the change and then re-creating the container to start with the updated image. Starting (i.e., cold-starting) a new container with a new image takes a significant amount of time.

Thus, the arrangement depicted in FIG. 2 allows containers to run in an isolated space (the namespace) and provides operating system facilities for each container as if each container had its own operating system.

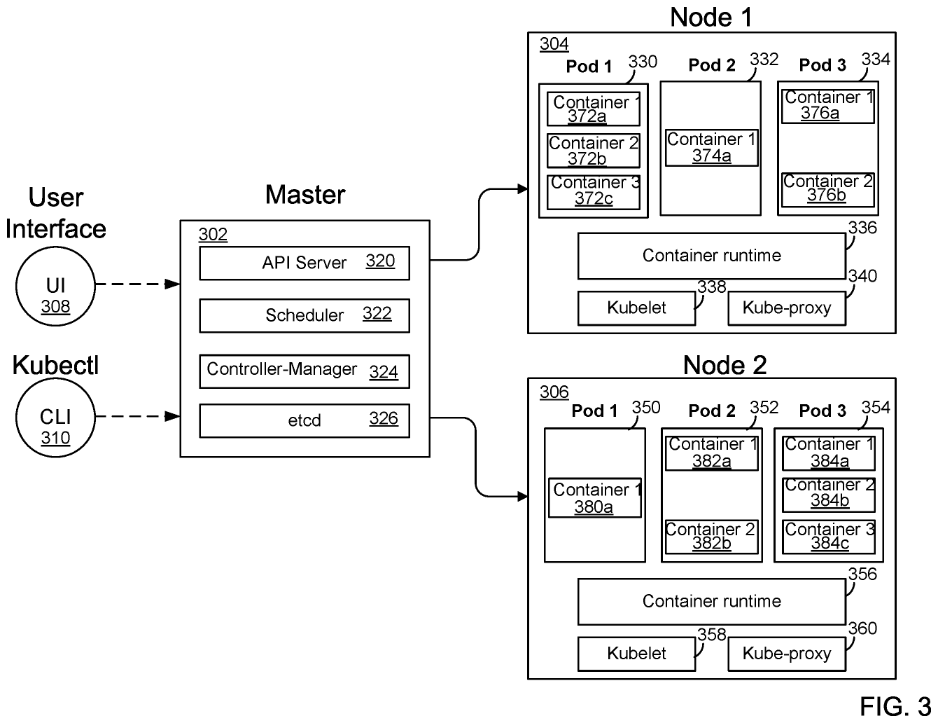

FIG. 3 depicts an arrangement for running containers with an orchestration system. The orchestration system, such as Kubernetes®, provides for a master node 302 and a cluster of worker nodes 304, 306 in which containers are run. Master node 302 is the control plane for the orchestrator and includes an API server 320, a scheduler 322, a controller manager 324, and a cluster store 326. API server 320 is the point of communication for all internal and external user components. Scheduler 322 watches API server 320 for new work and assigns new work to the nodes that can best handle the work. Controller manager 324 handles all of the control loops that monitor the cluster and respond to events in the cluster. Control loops include a node controller, an endpoints controller, and a replica set controller. Each controller runs as a background watch loop, constantly watching API server 320 for changes to maintain a desired state for the cluster. Cluster store 326, such as etcd, is a distributed database that stores the entire configuration and state of the cluster.

Worker node 304, 306 includes a Kubelet 338, 358, a container runtime 336, 356, and a network proxy 340, 360. Kubelet 338, 358 watches API server 320 for new work assignments. Container runtime 336, 356 performs container-related tasks, such as pulling images from the registry and starting and stopping containers. Network proxy 340, 360 is responsible for local cluster networking. A worker node 304 also contains one or more pods 330, 332, 334 and 350, 352, 354, which are an environment (i.e., sandbox) for running containers 372a-c, 374a, 376a-b and 380a, 382a-b, 384a-c, respectively. The pod environment includes a namespace, shared memory, volumes, and a network stack.

It is noted that while certain embodiments are described herein with respect to Kubernetes® orchestration system, other types of orchestration systems may alternatively be used.

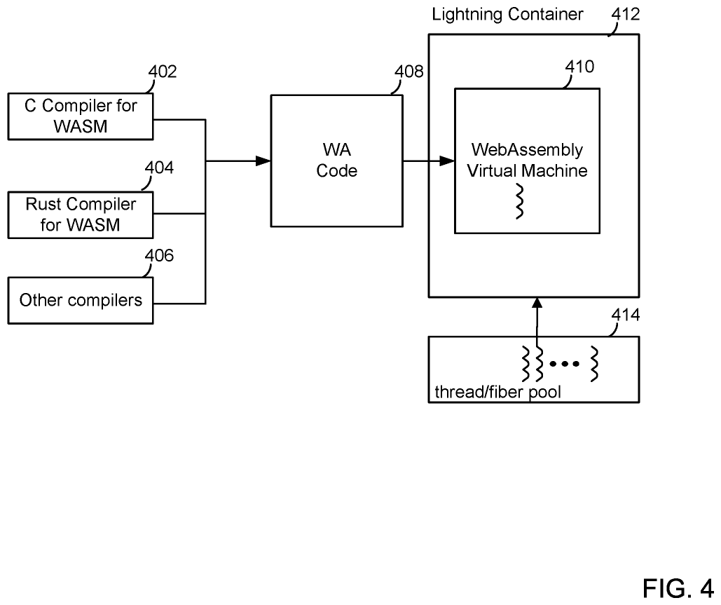

FIG. 4 depicts a WebAssembly arrangement. WebAssembly (WASM) is a standard defining a portable ISA, a platform-independent binary code format for executables, and an assembly language specification. It enables compilers 402, 404, 406 for programming languages, such as C, Rust, and other programming languages, to be compiled into platform-independent binary code WA 408 and executed in a WASM virtual machine (WASM VM) 410. WASM VM 410 thus enables the execution of platform-independent application code and sandboxing. In the figure, a lightning container (LC) 412 is a WASM VM 408 running in a thread or green thread assigned from a pool 414 of threads/fibers to execute WebAssembly code 408.LC 412 runs in a proxy plugin managed by a container manager, which operates as a container runtime interface with a Kubelet in the orchestrator.

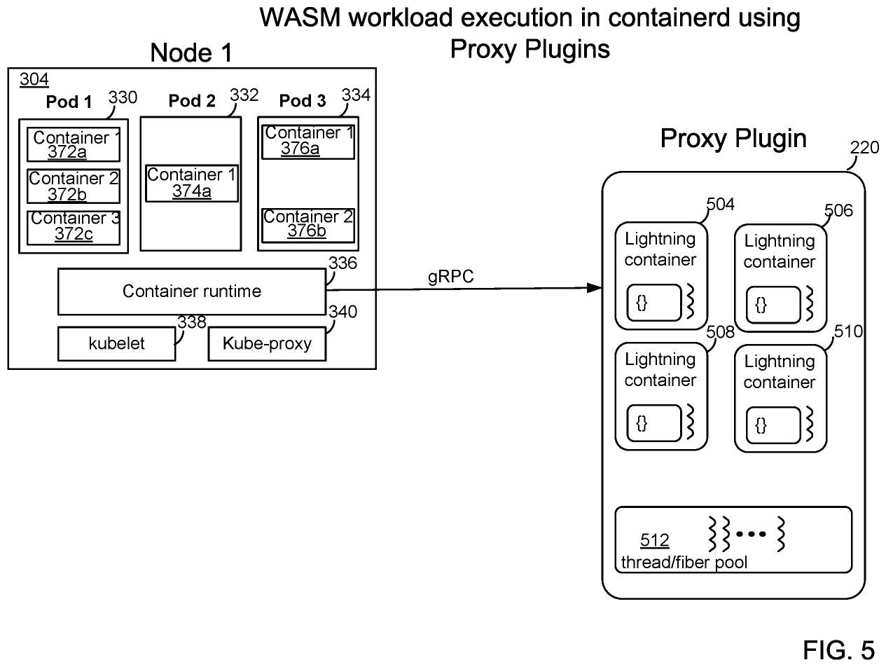

FIG. 5 depicts an arrangement for running containers with a proxy-plugin process, in an embodiment. In the figure, proxy-plugin process 220 is a process that runs one or more LCs 504, 506, 508, 510. Each LC 504, 506, 508, 510 is a WASM VM, which runs a container application on behalf of a node, such as node 304. Each LC 504, 506, 508, 510 runs on a pre-created thread or fiber (a lightweight cooperative thread) from a pool of threads/fibers to which workloads (i.e., applications) are assigned. The proxy-plugin process 220 is activated only once, thus reducing cold-start times because once started, it is not restarted for new workloads, and it re-uses the existing threads of a thread/fiber pool 512. Returning threads to the thread/fiber pool upon termination of a workload and re-using the threads without restarting the process saves tens of milliseconds because cold-start times of containers are avoided. The proxy-plugin process 220 can be written in any programming language, such as C or Rust.

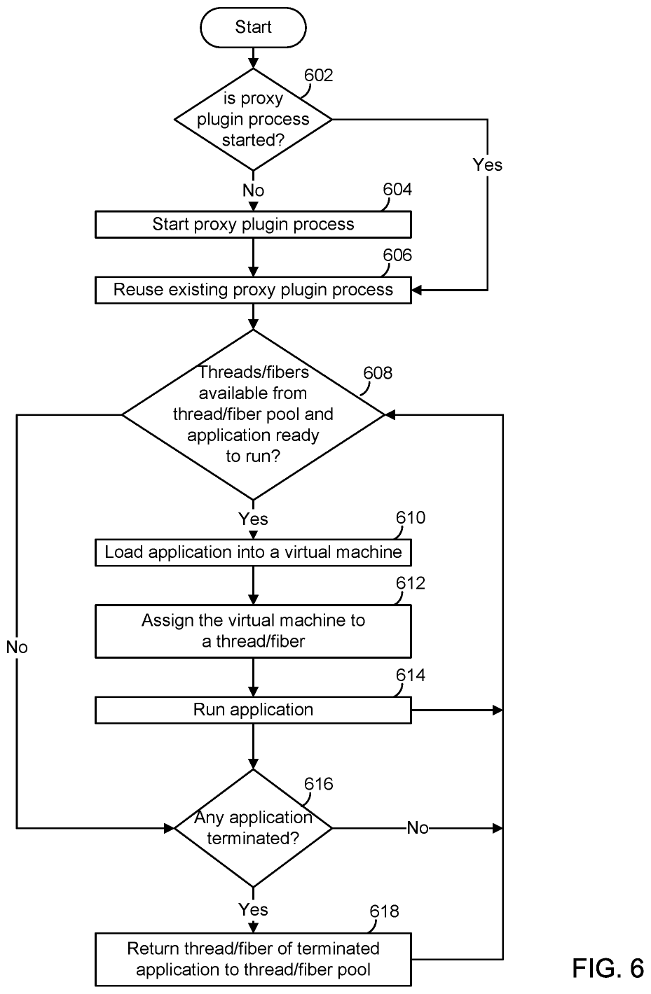

FIG. 6 depicts a flow of operations for running applications, in an embodiment. In step 602, a worker node of the orchestration system determines whether the proxy plugin process is started. If not, then in step 604, the worker node starts the proxy plugin process. If the proxy plugin process is started, then in step 606, the worker node uses or re-uses the existing proxy plugin process. In step 608, the proxy plugin determines whether any threads/fibers are available from the thread/fiber pool and whether any applications are ready to run. If so, then in step 610, the proxy plugin loads a ready application into a virtual machine, and in step 612, it assigns the virtual machine to an available thread or fiber. In step 614, the proxy plugin causes the application to run in the virtual machine. Flow then returns to step 608 to determine if threads or fibers are still available in the pool and if additional applications are ready to run. If so, steps 608-614 repeat until no more applications or threads/fibers are available. If no more threads/fibers are available, but there are applications ready to run, then in step 616, the proxy plugin process waits for one of the applications to terminate. In step 618, the thread or fiber assigned to the virtual machine is returned to the pool, and flow continues in step 608 to determine if another application can run.

The various embodiments described herein may employ various computer-implemented operations involving data stored in computer systems. For example, these operations may require physical manipulation of physical quantities. Usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer-readable media. The term computer-readable medium refers to any data storage device that can store data which can thereafter be input to a computer system-computer-readable media may be based on any existing or subsequently developed technology for embodying computer programs in a manner that enables them to be read by a computer. Examples of a computer-readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers.” OS-less containers implement operating system-level virtualization, wherein an abstraction layer is provided on top of the kernel of an operating system on a host computer. The abstraction layer supports multiple OS-less containers, each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for reducing startup times of applications, the method comprising:
starting a proxy plugin process coupled to a worker node of an orchestration system, the proxy plugin process including a pool of threads or fibers for running applications;
loading a first application into a first virtual machine;
assigning one thread or fiber from the pool to the first virtual machine to run the first application;
running the first application;
loading a second application into a second virtual machine;
assigning one other thread or fiber from the pool to the second virtual machine to run the second application;
running the second application; and
upon termination of the first application, returning the one thread or fiber to the pool for re-use by other applications.

2. The method of claim 1, wherein the first and second virtual machines run as lightning containers.

3. The method of claim 1, wherein the first virtual machine and second virtual machine are WebAssembly virtual machines that run platform-independent binary code.

4. The method of claim 3, wherein the platform-independent binary code is generated by compiling a programming language.

5. The method of claim 1,
wherein the worker node includes a container runtime; and
wherein the proxy plugin process is coupled via remote procedure calls to the container runtime.

6. The method of claim 1,
wherein the orchestration system has a command line interface to a master node; and
wherein loading and running the first application and the second application are performed by a user accessing the master node via the command line interface.

7. The method of claim 1, wherein the orchestration system is a Kubernetes orchestration system.

8. A system for reducing startup times of applications, the system comprising:
a proxy plugin process that includes a pool of threads or fibers for running applications; and
an orchestration system having a master node, and a worker node that is coupled to the proxy plugin process;
wherein the worker node is configured to:
load a first application into a first virtual machine;
assign one thread or fiber from the pool to the first virtual machine to run the first application;
run the first application;
load a second application into a second virtual machine;
assign one other thread or fiber from the pool to the second virtual machine to run the second application;
run the second application; and
return the one thread or fiber to the pool for re-use by other applications upon termination of the first application.

9. The system of claim 8, wherein the first and second virtual machines run as lightning containers.

10. The system of claim 8, wherein the first virtual machine and second virtual machine are WebAssembly virtual machines that run platform-independent binary code.

11. The system of claim 10, wherein the platform-independent binary code is generated by compiling a programming language.

12. The system of claim 8,
wherein the worker node includes a container runtime; and
wherein the proxy plugin process is coupled via remote procedure calls to the container runtime.

13. The system of claim 8,
wherein the orchestration system has a command line interface to the master node; and
wherein the worker node being configured to perform the loading and running of the first application includes the master node being configured to receive commands via the command line interface requesting the worker node perform the loading and running.

14. The system of claim 8, wherein the orchestration system is a Kubernetes orchestration system.

15. A non-transitory computer-readable medium comprising instructions executable in a computer system, wherein the instructions, when executed in the computer system, cause the computer system to carry out a method for reducing startup times of applications, the method comprising:
starting a proxy plugin process coupled to a worker node of an orchestration system, the proxy plugin process including a pool of threads or fibers for running applications;
loading a first application into a first virtual machine;
assigning one thread or fiber from the pool to the first virtual machine to run the first application;
running the first application;
loading a second application into a second virtual machine;
assigning one other thread or fiber from the pool to the second virtual machine to run the second application;
running the second application; and
upon termination of the first application, returning the one thread or fiber to the pool for re-use by other applications.

16. The non-transitory computer-readable medium of claim 15, wherein the first and second virtual machines run as lightning containers.

17. The non-transitory computer-readable medium of claim 15, wherein the first virtual machine and second virtual machine are WebAssembly virtual machines that run platform-independent binary code.

18. The non-transitory computer-readable medium of claim 17, wherein the platform-independent binary code is generated by compiling a programming language.

19. The non-transitory computer-readable medium of claim 15,
wherein the worker node includes a container runtime; and
wherein the proxy plugin process is coupled via remote procedure calls to the container runtime.

20. The non-transitory computer-readable medium of claim 15,
wherein the orchestration system has a command line interface to a master node; and
wherein loading and running the first application and the second application are performed by a user accessing the master node via the command line interface.
